(19) United States
(12) Patent Application Publication
(10) Pub. No.: US 2026/0147731 A1
(43) Pub. Date: May 28, 2026

(54) SYSTEMS AND METHODS FOR MANAGING BIG DATA PIPELINE PROCESSES

(71) Applicant: Verizon Patent and Licensing Inc., Basking Ridge, NJ (US)

(72) Inventor: Freddy Eduardo RODRIGUEZ, Waxahachie, TX (US)

(73) Assignee: Verizon Patent and Licensing Inc., Basking Ridge, NJ (US)

(21) Appl. No.: 18/957,055

(22) Filed: Nov. 22, 2024

(51) Int. Cl. G06F 16/14; G06F 3/06

(52) U.S. Cl. CPC G06F 16/14; G06F 3/0604; G06F 3/0649; G06F 3/067

(57) ABSTRACT

A device may receive data request information that includes business requirement information, pipeline information, and dataset information, and may process the data request information to generate metadata. The device may store the metadata in a repository, and may validate the metadata in the repository based on validation rules and to generate validated metadata. The device may determine whether the validated metadata is approved or disapproved, and may selectively merge the validated metadata to the repository based on the validated metadata being approved or notify a requester based on the validated metadata being disapproved.

### BACKGROUND

Big data platforms, particularly those operating on a Data-as-a-Service (DaaS) model, face many challenges associated with efficiently handling multitudes of data requests from end users.

### BRIEF DESCRIPTION OF THE DRAWINGS

FIGS. 1A-1F are diagrams of an example associated with managing big data pipeline processes.

FIG. 2 is a diagram of an example environment in which systems and/or methods described herein may be implemented.

FIG. 3 is a diagram of example components of one or more devices of FIG. 2.

FIG. 4 is a flowchart of an example process for managing big data pipeline processes.

### DETAILED DESCRIPTION OF EXAMPLE EMBODIMENTS

The following detailed description of example implementations refers to the accompanying drawings. The same reference numbers in different drawings may identify the same or similar elements.

A big data platform requires data engineers to meticulously store and manage a wide array of intricate data pipeline information, which may include diverse business requirements, ingestion specifics, and extensive dataset details. For example, a big data platform may collect, process, manage, and analyze large-scale network data. The network data may be collected from various network nodes, such as routers, base stations, switches, and other networking devices. The big data platform may handle real-time network data feeds, may ensure low-latency network data processing, and may process large volumes of network data in batches. The big data platform may process large network data sets with a parallel, distributed model, and may utilize machine learning models for anomaly detection, predictive analytics, and network optimization. The big data platform may utilize the network data for network performance monitoring, security and threat detection, network traffic analysis, network capacity planning, fault management,

However, as the big data platform scales and a quantity of data pipelines proliferates into thousands, the complexity and the volume of maintaining such granular information can become overwhelming. The complexity is compounded by the turnover within teams of data engineers who contribute to and manage the big data platform. Thus, current techniques for handling big data platforms consume computing resources (e.g., processing resources, memory resources, communication resources, and/or the like), networking resources, and/or other resources associated with incorrectly managing data pipeline information, generating incorrect information based on incorrectly managing data pipeline information, failing to satisfy business requirements of end users, handling dissatisfied end users, and/or the like.

Some implementations described herein provide a data system that manages big data pipeline processes. For example, the data system may receive data request information that includes business requirement information, pipeline information, and dataset information, and may process the data request information to generate metadata. The data system may store the metadata in a repository, and may validate the metadata in the repository based on validation rules and to generate validated metadata. The data system may determine whether the validated metadata is approved or disapproved, and may selectively merge the validated metadata to the repository based on the validated metadata being approved or notify a requester based on the validated metadata being disapproved.

In this way, the data system manages big data pipeline processes. For example, the data system may receive data request information that includes business requirements, pipeline specifications, and dataset characteristics, and may process the data request information to generate metadata in a standardized format using a pre-established schema. The data system may store the standardized metadata in a centralized repository with stringent security measures and version control capabilities. The repository design may ensure that the standardized metadata remains secure while easily retrievable for authorized usage. The data system may validate the standardized metadata based on predetermined rules to ensure compliance and to yield validated metadata. Depending on validation outcomes, the validated metadata is either merged into the repository or end users are notified for corrective measures. Thus, the data system may conserve computing resources, networking resources, and/or other resources that would have otherwise been consumed by incorrectly managing data pipeline information, generating incorrect information based on incorrectly managing data pipeline information, failing to satisfy business requirements of end users, handling dissatisfied end users, and/or the like.

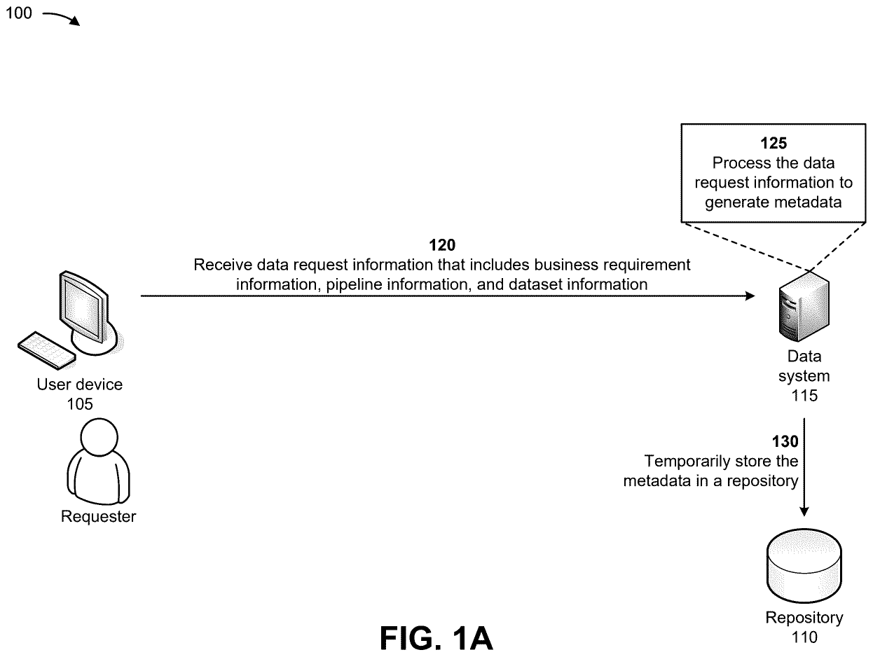

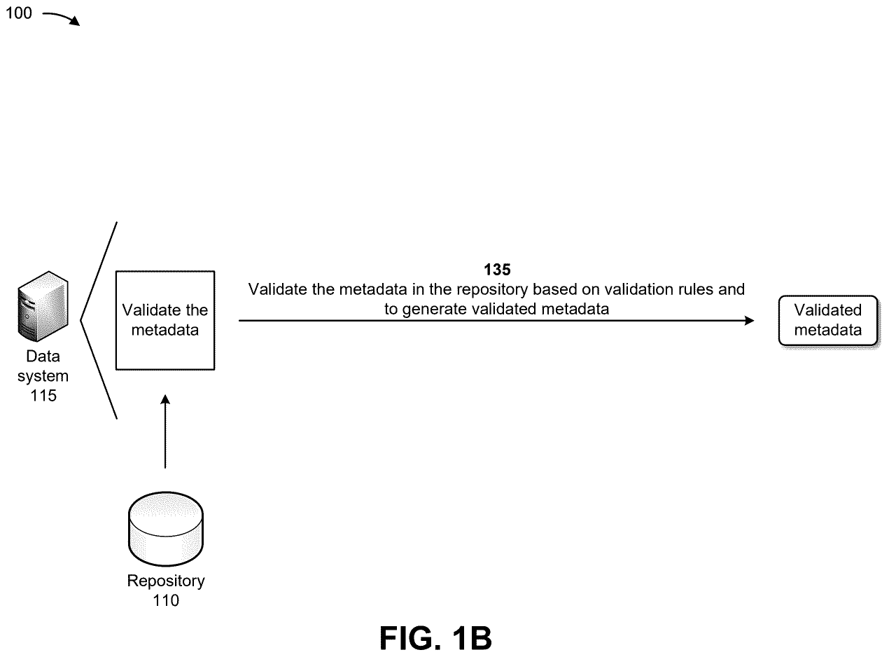

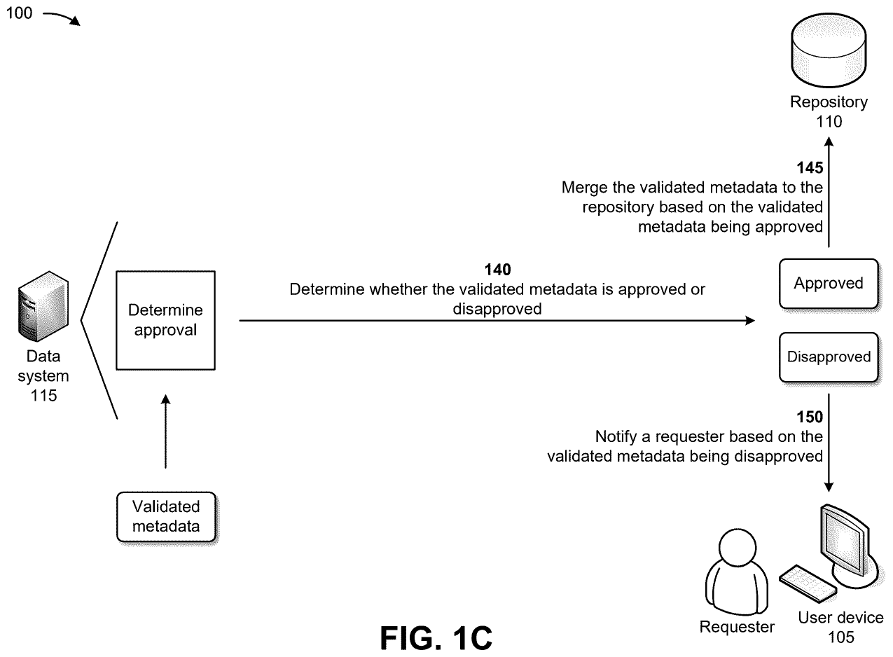

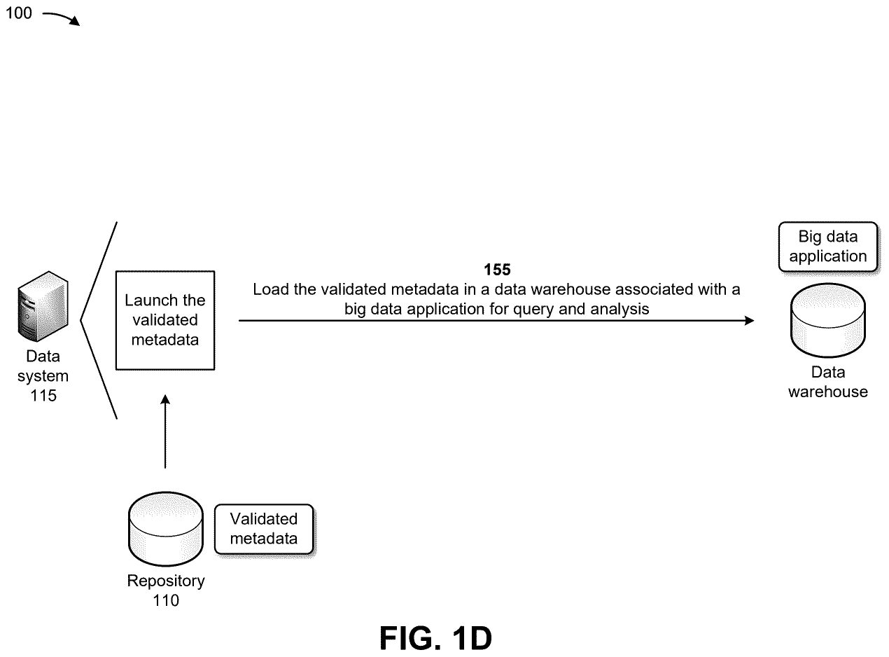

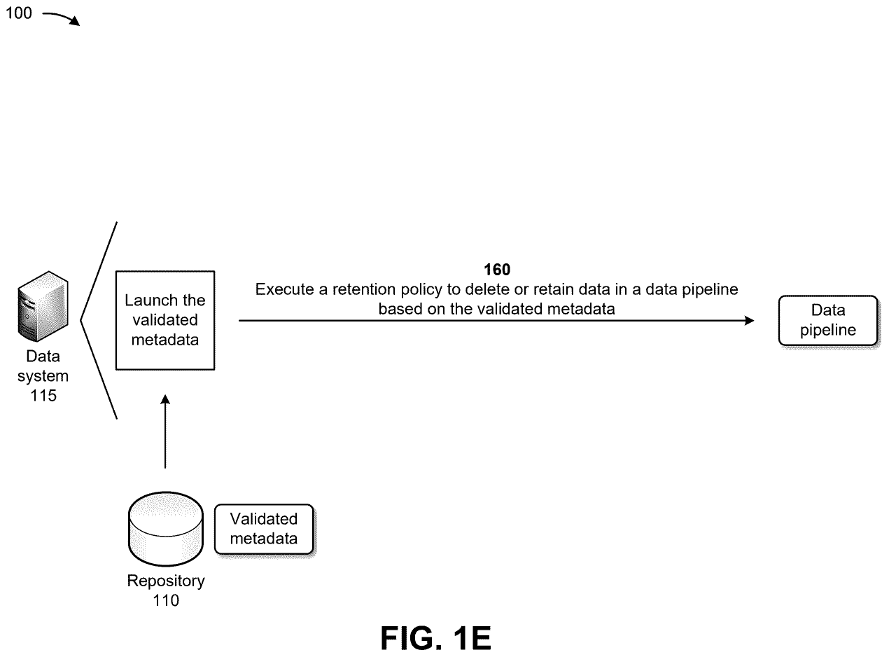

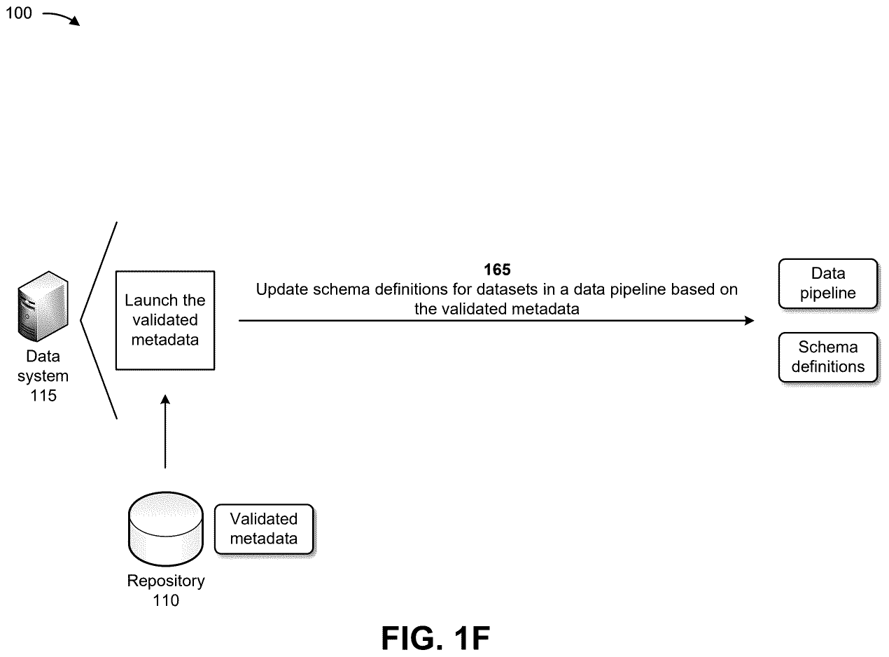

FIGS. 1A-1F are diagrams of an example 100 associated with managing big data pipeline processes. As shown in FIGS. 1A-1F, example 100 includes a user device 105 associated with a requester, a repository 110, and a data system 115. Although a single user device 105 and a single repository 110 are depicted in the example 100, in some implementations, the data system 115 may be associated with multiple user devices 105 and/or multiple repositories 110. Further details of the user device 105, the repository, and the data system 115 are provided elsewhere herein.

As shown by FIG. 1A, and by reference number 120, the data system 115 may receive data request information that includes business requirement information, pipeline information, and dataset information. For example, the data system 115 may receive data request information from a user device 105 operated by a requester. In some implementations, the data system 115 may provide, the user device 105, a web portal that allows the requester to easily input the data request information. For example, the data system 115 may provide a user interface to the user device 105. The user interface may include drop-downs, checkboxes, and input fields designed to capture comprehensive data request details, simplifying the process for data engineers. A user-friendly interface may ensure that all relevant information is efficiently and accurately captured, reducing errors and improving the standardization of metadata requests. In some implementations, the data system 115 may provide an automated user feedback loop that informs the requester of a status of the data request. For example, the data system 115 may generate automatic feedback messages specifying areas of non-compliance and suggesting revisions if a data request fails validation. This automated approach may accelerate the approval process and may ensure that all metadata records are accurate and up to date.

The data request information may include various types of information pertinent to managing big data pipelines, including specific business requirements, technical details about the pipeline, and characteristics of the datasets involved. These details ensure that all necessary information is collected for further processing and standardization. In some implementations, the data request information may include a request to add a data pipeline to a big data platform utilizing a DaaS model.

The business requirements may include objectives and goals that a data pipeline is intended to achieve. This information may align technical details of the data pipeline with business needs and may ensure that generated data will be useful for decision-making or other business purposes. For example, the business requirements information may include information about objectives (e.g., high-level goals, such as improving data analytics capabilities, enhancing reporting accuracy, or optimizing operational efficiencies), key performance indicators (KPIs) that measure the success of the data pipeline, stakeholders (e.g., individuals or teams with a vested interest in the data pipeline), project timelines (e.g., a start date, an end date, and any critical milestones), data usage (e.g., a description of how the data will be used within the business context), and/or the like.

The pipeline information may describe an architecture and configuration of the data pipeline, such as details about data sources, processes involved in transforming and moving data, and any tools or technologies to be utilized. For example, the pipeline information may include information about data sources (e.g., types and locations of the source data, such as databases, application programming interfaces (APIs), file systems, or external data sources), ingestion methods (e.g., techniques for importing data into the data pipeline, such as batch processing or real-time streaming), data transformation (e.g., steps for cleansing, normalizing, aggregating, or otherwise transforming data to meet schema and quality requirements), orchestration (e.g., tools and workflows used for managing and scheduling various tasks in the data pipeline), storage (e.g., where the data will be stored during and after processing, such as data lakes or data warehouses), security measures (e.g., policies for ensuring data security and compliance, such as encryption, access controls, and logging), and/or the like.

The dataset information may provide specifics about the data, including structure, quality, and management policies. For example, the dataset information may include information about schema (e.g., definitions of the dataset's structure, columns, data types, and any constraints), size and volume (e.g., expected sizes of the datasets, including row counts and storage requirements), frequency (e.g., how often the data is updated or refreshed, such as hourly, daily, or weekly), retention policies (e.g., rules that dictate how long data is stored and when the data should be archived or deleted), data quality metrics (e.g., standards and validation rules for ensuring the data is accurate, complete, and reliable), metadata (e.g., descriptive details that provide context about the dataset, such as source system name, dataset name, description, and data lineage), and/or the like.

To handle various data formats commonly encountered in a big data platform, the data system 115 may manage a wide range of data types, such as comma separated values (CSV), JavaScript object notation (JSON), and extensible markup language (XML). The data system 115 may automatically detect and convert these formats into a standardized schema, ensuring that all datasets, regardless of their initial format, can be processed and integrated into the repository 110 efficiently. Furthermore, the ability to manipulate diverse data formats enhances the versatility and adaptability of the big data platform, accommodating various data sources and use cases.

As further shown in FIG. 1A, and by reference number 125, the data system 115 may process the data request information to generate metadata. For example, the data system 115 may process the business requirement information, the pipeline information, and the dataset information of the data request information using a predefined metadata schema and to transform the data request information into a standardized format of metadata (e.g., standardized metadata). The standardized metadata generation process may incorporate original details provided in the data request information and may structure the original details according to rules and formats defined by the metadata schema to ensure consistency and uniformity. Additionally, the data system 115 may enable customizable metadata schema to be defined by the requester. For example, the data system 115 may enable data platforms (e.g., requesters) to dynamically define the metadata schema to include fields, such as a source system name, a dataset name, a detailed description of the dataset, an active status, data frequency (e.g., both granularity and values), data retention policies (e.g., granularity and values), a priority of the dataset, and/or the like. This customizable approach may enable different requesters to tailor metadata to support unique use cases and operational requirements, ensuring that all critical information is systematically captured and readily available for query and analysis.

The data system 115 supports dynamic customization of the metadata schema to meet specific requirements of a data engineer. This customization may enable data engineers to define and adjust key attributes of the metadata schema according to specific use cases and operational demands. Attributes like source system name, dataset name, detailed description, active status, retention policies, and priority levels can be freely added or modified. This flexibility ensures that the metadata collection process is adaptable and capable of evolving in response to changing business needs and data governance requirements.

As further shown in FIG. 1A, and by reference number 130, the data system 115 may temporarily store the metadata in the repository 110. For example, the data system 115 may provide the standardized metadata to the repository 110 for temporary storage. The repository 110 may include a secure storage location for the newly created metadata, providing both version control and stringent security measures. The repository 110 may enable the metadata to be easily retrieved and subjected to subsequent validation steps by the data system 115, while ensuring that the metadata remains protected and organized. In some implementations, the data system 115 may cause a branch to be created in the repository 110, and may temporarily store the standardized metadata in the branch of the repository 110 (e.g., via a continuous integration(CI)/continuous deployment (CD) pipeline).

As shown in FIG. 1B, and by reference number 135, the data system 115 may validate the metadata in the repository 110 based on validation rules and to generate validated metadata. For example, the data system 115 may retrieve the standardized metadata from the repository 110, and may subject the standardized metadata to a series of validation checks. The validation checks may be defined by predetermined rules specified by the data system 115. The validation rules may include compliance with data retention policies, adherence to naming conventions, format correctness, correctness of metadata schema, data type validations, value range validations, and other preconfigured criteria. The validation rules may ensure that the metadata conforms to operational standards and requirements set by a big data platform.

After applying the validation rules, the data system 115 may classify the metadata as either validated or invalidated based on the results of the validation checks. If all validation conditions are satisfied, the data system 115 may classify the metadata as validated. If all validation conditions are not satisfied, the data system 115 may classify the metadata as invalidated. By ensuring that only valid metadata is further processed, the data system 115 may maintain a high standard of data integrity and usefulness. In some implementations, the validation process may also include the data system 115 utilizing automated tools and techniques. For example, the data system 115 may utilize scripts or software components to systematically verify each aspect of the metadata against the validation rules. The validation phase may maintain the operational efficiency of big data pipelines, and may mitigate potential errors that could arise from incorrect or non-compliant metadata.

In some implementations, validating the metadata may include the data system 115 validating the metadata for compliance with data retention policies. For example, the data system 115 may check if the metadata conforms to organizational policies for data retention, ensuring that only the required data is retained and purged according to predefined rules.

Additionally, or alternatively, validating the metadata may include the data system 115 validating the metadata for compliance with predefined naming conventions. For example, the data system 115 may verify that all metadata adheres to standardized naming conventions, promoting consistency and easier management. In some implementations, the data system 115 may receive subsequent data requests to change attributes of a data pipeline, and may modify the validated metadata accordingly. For example, the data system 115 may process subsequent requests for changes in the data pipeline and may update the existing validated metadata to reflect these changes accurately.

As shown by FIG. 1C, and by reference number 140, the data system 115 may determine whether the validated metadata is approved or disapproved. For example, the data system 115 may apply approval criteria to the validated metadata to determine whether the validated metadata is approved or disapproved. This determination may include checking the validated metadata against pre-established metrics or standards set by an organization. The criteria may ensure that the validated metadata is thoroughly vetted for accuracy, completeness, and relevance before final acceptance. In some cases, this may include automated processes or manual review steps to ensure rigor in the validation process. In some implementations, the data system 115 may provide the validated metadata to a data engineer for approval or disapproval. In some implementations, the data system 115 may determine that the validated metadata is approved (e.g., based on receiving an approval from the data engineer). Alternatively, the data system 115 may determine that the validated metadata is disapproved (e.g., based on receiving a disapproval from the data engineer).

As further shown in FIG. 1C, and by reference number 145, the data system 115 may merge the validated metadata to the repository 110 based on the validated metadata being approved. For example, when the data system 115 determines that the validated metadata is approved, the data system 115 may provide the validated metadata to the repository 110 for storage. In some implementations, the data system 115 may generate a branch in the repository 110 and may merge the validated metadata in the branch of the repository 110. Creation of the branch creation may enable version control and systematic tracking of changes made to the validated metadata. The merging of the validated metadata may ensure that the validated metadata is integrated into a main dataset of the repository 110, providing a centralized source of the validated metadata.

As further shown in FIG. 1C, and by reference number 150, the data system 115 may notify a requester based on the validated metadata being disapproved. For example, when the data system 115 determines that the validated metadata is disapproved, the data system 115 may generate a notification indicating that the validated metadata is disapproved. The data system 115 may then provide the notification to the user device 105, and the user device 105 may display the notification to the requester. The notification may include details on what aspects of the validated metadata caused the disapproval, offering the requester insight into necessary corrections or further actions required. By effectively communicating disapprovals, the data system 115 may ensure that requesters are informed promptly and can take corrective measures to meet the required standards.

In some implementations, based on the notification, the data system 115 may receive subsequent data requests to change attributes of a data pipeline, and may modify the validated metadata based on these subsequent data requests. For example, the requester may submit additional data request information to alter specific attributes, necessitating corresponding updates to the validated metadata.

As shown in FIG. 1D, and by reference number 155, the data system 115 may load the validated metadata in a data warehouse associated with a big data application for query and analysis. For example, when the validated metadata is approved and merged to the repository 110, the data system 115 may perform one or more launch procedures with the validated metadata. In some implementations, a launch procedure may include loading the validated metadata in a data warehouse associated with a big data application for query and analysis. For example, the data system 115 may load the validated metadata into a data warehouse, making the validated metadata available for use in a big data application. This may ensure that the validated metadata is accessible and can be used in various analytical tasks, thus enabling effective data querying and comprehensive analysis within the big data application.

The validated metadata stored in the repository 110 may be readily utilized for comprehensive querying and analysis. The data system 115 may load this validated metadata into a data warehouse, allowing data engineers and business analysts to perform complex queries across the entire dataset. By querying the validated metadata, users can extract insights such as identifying all datasets stored in a particular format, datasets originating from specific data sources, or datasets fulfilling particular business criteria. This capability enhances the decision-making process by providing a holistic view of the data landscape within the big data platform.

As shown in FIG. 1E, and by reference number 160, the data system 115 may execute a retention policy to delete or retain data in a data pipeline based on the validated metadata. For example, when the validated metadata is approved and merged to the repository 110, the data system 115 may perform one or more launch procedures with the validated metadata. In some implementations, a launch procedure may include executing a retention policy to delete or retain data in a data pipeline based on the validated metadata. The execution of the retention policy may include reading retention attributes from the validated metadata and determining whether the data in the pipeline meets the conditions for retention or deletion. This procedure may ensure that data governance protocols are upheld, enhancing data lifecycle management within a big data platform. By systematically applying retention policies, the data system 115 may ensure that only relevant and compliant data is maintained, thereby optimizing storage resources and maintaining data integrity.

As shown in FIG. 1F, and by reference number 165, the data system 115 may update schema definitions for datasets in a data pipeline based on the validated metadata. For example, when the validated metadata is approved and merged to the repository 110, the data system 115 may perform one or more launch procedures with the validated metadata. In some implementations, a launch procedure may include updating schema definitions for datasets in a data pipeline based on the validated metadata. This may ensure that the schema definitions for datasets in the data pipeline remain consistent and up-to-date. The data system 115 may read schema definition attributes from the validated metadata and may apply necessary updates to the schema of the datasets in the data pipeline as defined by the validated metadata. Such updates may include changes to data types, structural modifications to the dataset, and/or adjustments in alignment with business requirements or data governance policies.

In some implementations, the data system 115 may utilize a microservices-based architecture to handle various functions of data pipeline process management. Each microservice may be responsible for a discrete function such as data ingestion, metadata generation, validation, and storage. This architecture may ensure scalability and fault tolerance, as different components can be scaled independently based on their load.

Data ingestion may occur through multiple channels, including APIs, streaming services, and file-based uploads. The ingested data may be subjected to a preprocessing phase where initial data quality and integrity checks are performed. This phase may ensure that data entering the data system 115 complies with basic schema requirements and is free from easily identifiable errors.

Upon passing the preprocessing stage, the data may be segmented into various tasks and distributed across the different microservices for further processing. Using a Kubernetes-based orchestration layer, the data system 115 may dynamically allocate computing resources to each microservice based on real-time data processing demands. For example, batch processing tasks may be handled by a dedicated microservice utilizing Apache Spark for distributed data processing, while real-time data streams may be processed via Apache Flink, ensuring low latency.

The metadata generation process may transform the structured data into a standardized format using JSON schemas predefined based on industry standards. Custom scripts written in Python or another scripting language may handle this transformation, allowing for future extensibility. Each piece of metadata may undergo a series of validation rules pre-configured within a metadata validator module. This module may employ rule engines, such as Drools to implement complex validation logic, ensuring compliance with data retention policies, naming conventions, and value ranges. The output from the validator module may be routed either to the repository 110 or back to the requester via a feedback loop for correction.

Lifecycle management of the metadata may be ensured via integration with version control systems such as Git. Each validated metadata entry results in a new branch within the repository 110, allowing for comprehensive version tracking and auditability. Security and access controls are enforced by leveraging OAuth2 for authentication and role-based access control (RBAC) for authorization, ensuring that only authorized personnel have access to sensitive operations within the data system 115.

To ensure data security, the data system 115 may employ multi-layer encryption protocols. In transit, data may be secured using transport layer security (TLS) protocols, ensuring data integrity and privacy. At rest, metadata and pipeline information may be encrypted using advanced encryption standard (AES) with a 256-bit key to safeguard against unauthorized access. In addition to strict encryption protocols, the data system 115 may implement access logging and monitoring components using Elasticsearch, Logstash, and Kibana (ELK) stack for real-time analytics and anomaly detection. This may enable proactive identification and mitigation of security threats. Furthermore, data handling policies may be strictly enforced. Data from varied sources such as relational databases, structured query language (SQL) databases, and streaming platforms may be normalized before ingestion. The data system 115 may include error handling mechanisms, such as retry policies for transient errors, with specific alerting thresholds set for persistent failures. These mechanisms may ensure high system reliability and availability.

In this way, the data system 115 manages big data pipeline processes. For example, the data system 115 may receive data request information that includes business requirements, pipeline specifications, and dataset characteristics, and may process the data request information to generate metadata in a standardized format using a pre-established schema. The data system 115 may store the standardized metadata in a centralized repository with stringent security measures and version control capabilities. The repository design may ensure that the standardized metadata remains secure while easily retrievable for authorized usage. The data system 115 may validate the standardized metadata based on predetermined rules to ensure compliance and to yield validated metadata. Depending on validation outcomes, the validated metadata is either merged into the repository or end users are notified for corrective measures. Thus, the data system 115 may conserve computing resources, networking resources, and/or other resources that would have otherwise been consumed by incorrectly managing data pipeline information, generating incorrect information based on incorrectly managing data pipeline information, failing to satisfy business requirements of end users, handling dissatisfied end users, and/or the like.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

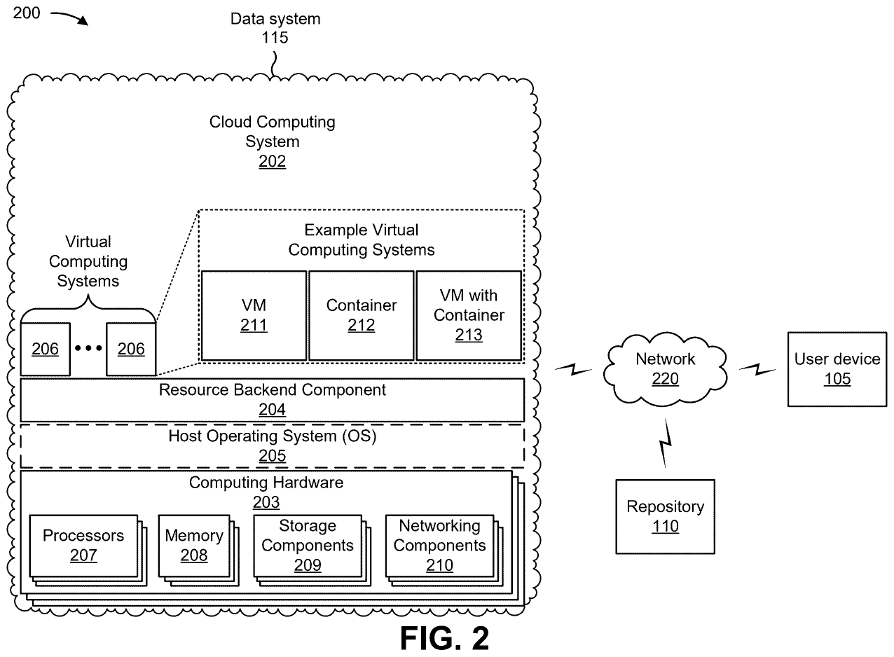

FIG. 2 is a diagram of an example environment 200 in which systems and/or methods described herein may be implemented. As shown in FIG. 2, the environment 200 may include the data system 115, which may include one or more elements of and/or may execute within a cloud computing system 202. The cloud computing system 202 may include one or more elements 203-213, as described in more detail below. As further shown in FIG. 2, the environment 200 may include the user device 105, the repository 110, and/or a network 220. Devices and/or elements of the environment 200 may interconnect via wired connections and/or wireless connections.

The user device 105 may include one or more devices capable of receiving, generating, storing, processing, and/or providing information, as described elsewhere herein. The user device 105 may include a communication device and/or a computing device. For example, the user device 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The repository 110 may include one or more devices capable of receiving, generating, storing, processing, and/or providing information, as described elsewhere herein. The repository 110 may include a communication device and/or a computing device. For example, the repository 110 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The repository 110 may communicate with one or more other devices of the environment 200, as described elsewhere herein.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

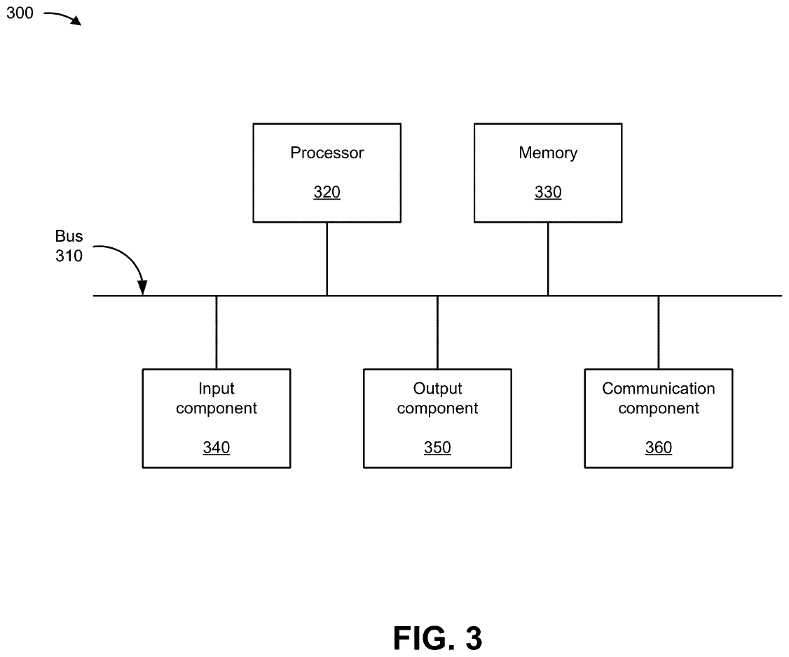

Although the data system 115 may include one or more elements 203-213 of the cloud computing system 202, may execute within the cloud computing system 202, and/or may be hosted within the cloud computing system 202, in some implementations, the data system 115 may not be cloud-based (e.g., may be implemented outside of a cloud computing system) or may be partially cloud-based. For example, the data system 115 may include one or more devices that are not part of the cloud computing system 202, such as the device 300 of FIG. 3, which may include a standalone server or another type of computing device. The data system 115 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the user device 105, the repository 110, and/or the data system 115. In some implementations, the user device 105, the repository 110, and/or the data system 115 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

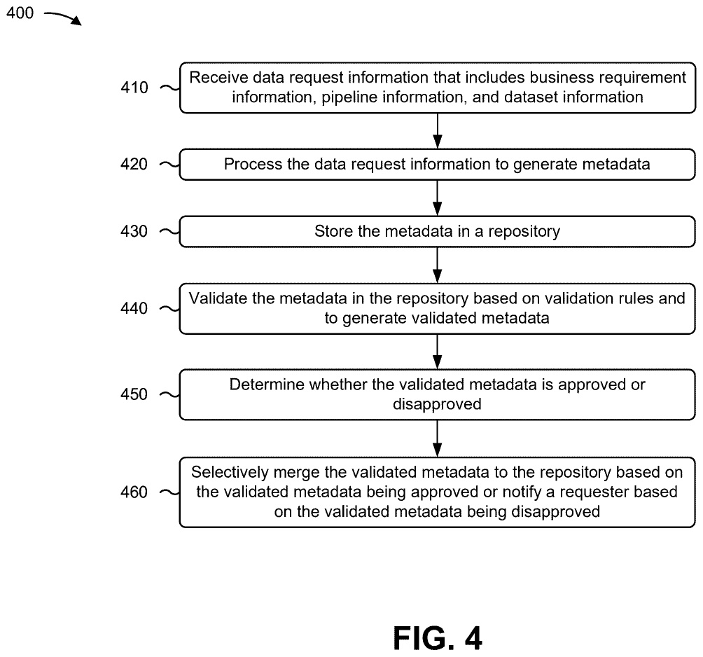

FIG. 4 is a flowchart of an example process 400 for managing big data pipeline processes. In some implementations, one or more process blocks of FIG. 4 may be performed by a device (e.g., the data system 115). In some implementations, one or more process blocks of FIG. 4 may be performed by another device or a group of devices separate from or including the device, such as a user device (e.g., the user device 105). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving data request information that includes business requirement information, pipeline information, and dataset information (block 410). For example, the device may receive data request information that includes business requirement information, pipeline information, and dataset information, as described above. In some implementations, the data request information includes a request to add a data pipeline to a big data platform utilizing a Data-as-a-Service model.

As further shown in FIG. 4, process 400 may include processing the data request information to generate metadata (block 420). For example, the device may process the data request information to generate metadata, as described above. In some implementations, processing the data request information to generate the metadata includes processing the data request information, using a predefined metadata schema, to generate the metadata in a standardized format.

As further shown in FIG. 4, process 400 may include storing the metadata in a repository (block 430). For example, the device may store the metadata in a repository, as described above. In some implementations, the repository is a centralized, protected repository with version control.

As further shown in FIG. 4, process 400 may include validating the metadata in the repository based on validation rules and to generate validated metadata (block 440). For example, the device may validate the metadata in the repository based on validation rules and to generate validated metadata, as described above. In some implementations, validating the metadata in the repository based on the validation rules and to generate the validated metadata includes validating the metadata for compliance with data retention policies. In some implementations, validating the metadata in the repository based on the validation rules and to generate the validated metadata includes validating the metadata for compliance with predefined naming conventions.

As further shown in FIG. 4, process 400 may include determining whether the validated metadata is approved or disapproved (block 450). For example, the device may determine whether the validated metadata is approved or disapproved, as described above.

As further shown in FIG. 4, process 400 may include selectively merging the validated metadata to the repository based on the validated metadata being approved or notifying a requester based on the validated metadata being disapproved (block 460). For example, the device may selectively merge the validated metadata to the repository based on the validated metadata being approved or notify a requester based on the validated metadata being disapproved, as described above. In some implementations, merging the validated metadata to the repository includes generating a branch in the repository, and storing the validated metadata in the branch. In some implementations, the requester generated the data request information.

In some implementations, process 400 includes performing one or more launch procedures based on merging the validated metadata to the repository. In some implementations, performing the one or more launch procedures includes loading the validated metadata in a data warehouse associated with a big data application for query and analysis. In some implementations, performing the one or more launch procedures includes executing a retention policy to delete or retain data in a data pipeline based on the validated metadata. In some implementations, performing the one or more launch procedures includes updating schema definitions for datasets in a data pipeline based on the validated metadata.

In some implementations, process 400 includes receiving subsequent data requests to change attributes of a data pipeline, and modifying the validated metadata based on the subsequent data requests to change the attributes of the data pipeline.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

1. A method, comprising:
receiving, by a device, data request information that includes business requirement information, pipeline information, and dataset information;
processing, by the device, the data request information to generate metadata using a metadata schema included in the data request information;
storing, by the device, the metadata in a repository;
validating, by the device, the metadata in the repository based on validation rules to generate validated metadata;
determining, by the device and based on applying approval criteria to the validated metadata, whether the validated metadata is approved or disapproved; and
selectively:
merging, by the device, the validated metadata to the repository based on the validated metadata being approved; or
notifying, by the device, a requester based on the validated metadata being disapproved.

2. The method of claim 1, further comprising:
performing one or more launch procedures based on merging the validated metadata to the repository.

3. The method of claim 2, wherein performing the one or more launch procedures comprises:
loading the validated metadata in a data warehouse associated with a big data application for query and analysis.

4. The method of claim 2, wherein performing the one or more launch procedures comprises:
executing a retention policy to delete or retain data in a data pipeline based on the validated metadata.

5. The method of claim 2, wherein performing the one or more launch procedures comprises:
updating schema definitions for datasets in a data pipeline based on the validated metadata.

6. The method of claim 1, wherein processing the data request information to generate the metadata comprises:
processing the data request information, using the metadata schema, to generate the metadata in a standardized format.

7. The method of claim 1, wherein the repository is a centralized, protected repository with version control.

8. A device, comprising:
one or more processors configured to:
receive data request information that includes business requirement information, pipeline information, and dataset information;
process the data request information to generate metadata using a customized metadata schema included in the data request information;
store the metadata in a repository,
wherein the repository is a centralized, protected repository with version control;
validate the metadata in the repository based on validation rules to generate validated metadata;
determine, based on applying approval criteria to the validated metadata, whether the validated metadata is approved or disapproved; and
selectively:
merge the validated metadata to the repository based on the validated metadata being approved; or
notify a requester based on the validated metadata being disapproved.

9. The device of claim 8, wherein the one or more processors, to merge the validated metadata to the repository, are configured to:
generate a branch in the repository; and
store the validated metadata in the branch.

10. The device of claim 8, wherein the one or more processors, to validate the metadata in the repository are configured to:
validate the metadata for compliance with data retention policies.

11. The device of claim 8, wherein the one or more processors, to validate the metadata in the repository are configured to:
validate the metadata for compliance with predefined naming conventions.

12. The device of claim 8, wherein the one or more processors are further configured to:
receive subsequent data requests to change attributes of a data pipeline; and
modify the validated metadata based on the subsequent data requests to change the attributes of the data pipeline.

13. The device of claim 8, wherein the data request information includes a request to add a data pipeline to a big data platform utilizing a Data-as-a-Service model.

14. The device of claim 8, wherein the requester generated the data request information.

15. A non-transitory computer-readable medium storing a set of instructions, the set of instructions comprising:
one or more instructions that, when executed by one or more processors of a device, cause the device to:
receive data request information that includes business requirement information, pipeline information, and dataset information,
wherein the data request information includes a request to add a data pipeline to a big data platform utilizing a Data-as-a-Service model;
process the data request information to generate metadata using a customized metadata schema included in the data request information;
store the metadata in a repository;
validate the metadata in the repository based on validation rules to generate validated metadata;
determine, based on applying approval criteria to the validated metadata, whether the validated metadata is approved or disapproved; and
selectively:
merge the validated metadata to the repository based on the validated metadata being approved; or
notify a requester based on the validated metadata being disapproved.

16. The non-transitory computer-readable medium of claim 15, wherein the one or more instructions further cause the device to one or more of:
load the validated metadata in a data warehouse associated with a big data application for query and analysis;
execute a retention policy to delete or retain data in a data pipeline based on the validated metadata; or
update schema definitions for datasets in a data pipeline based on the validated metadata.

17. The non-transitory computer-readable medium of claim 15, wherein the one or more instructions, that cause the device to process the data request information to generate the metadata, cause the device to:
process the data request information, using the customized metadata schema, to generate the metadata in a standardized format.

18. The non-transitory computer-readable medium of claim 15, wherein the one or more instructions, that cause the device to merge the validated metadata to the repository, cause the device to:
generate a branch in the repository; and
store the validated metadata in the branch.

19. The non-transitory computer-readable medium of claim 15, wherein the one or more instructions, that cause the device to validate the metadata in the repository, cause the device to:
validate the metadata for compliance with data retention policies or predefined naming conventions.

20. The non-transitory computer-readable medium of claim 15, wherein the one or more instructions further cause the device to:
receive subsequent data requests to change attributes of a data pipeline; and
modify the validated metadata based on the subsequent data requests to change the attributes of the data pipeline.
